(19) United States
(12) Patent Application Publication
(10) Pub. No.: US 2012/0311722 A1
(43) Pub. Date: Dec. 6, 2012

(54) ELECTRONIC SYSTEMS WITH DATA PROTECTION FUNCTIONS

(76) Inventors: Shaolan Wang, Beijing (CN); Hongning Zeng, Beijing (CN)

(21) Appl. No.: 13/162,411

(22) Filed: Jun. 16, 2011

(30) Foreign Application Priority Data
May 31, 2011 (CN) 201110147783.2

(51) Int. Cl. G06F 21/00

(52) U.S. Cl. 726/28

(57) ABSTRACT

A communication component sends a request of an action list to a server if information fails to pass authentication. A control component processes content stored in an electronic device according to a reply generated in response to the request. The reply includes the action list. The processing is performed according to an action included in the action list.

### RELATED APPLICATION

This application claims priority to Patent Application No. 201110147783.2, tiled “Electronic Systems with Data Protection Functions,” filed on May 31, 2011, with the State Intellectual Property Office of the People's Republic of China.

### BACKGROUND

Computer devices such as laptops, palmtop computers, and smartphones have become common in some areas of the world. Users may store important and confidential data in the computer devices and may install applications that allow access to applications in intranets associated with the users. If the computer device is lost or stolen, an authorized user may obtain important and confidential data, and may also execute the applications. Thus, preventive measures would be beneficial.

### SUMMARY

In one embodiment, computer-executable components stored on a non-transitory computer-readable storage medium include a communication component and a control component. The communication component can send a request for an action list to a server if information fails to pass authentication. The control component can process content stored in an electronic device according to a predefined action and a reply generated in response to the request. The reply includes the action list. The processing is performed according to an action included in the action list.

### BRIEF DESCRIPTION OF THE DRAWINGS

Features and advantages of embodiments of the claimed subject matter will become apparent as the following detailed description proceeds, and upon reference to the drawings, wherein like numerals depict like parts, and in which:

FIG. 1 illustrates a block diagram of an example of a network, in accordance with one embodiment of the present invention.

FIG. 2 illustrates an example of a software topology for a client-end device, in accordance with one embodiment of the present invention.

FIG. 3 illustrates a flowchart of an example of a data protection/recovery process performed by a client-end device, in accordance with one embodiment of the present invention.

FIG. 4 illustrates a flowchart of an example of a tracking process performed by a client-end device, in accordance with one embodiment of the present invention.

FIG. 5 illustrates a flowchart of examples of operations performed by a client-end device, in accordance with one embodiment of the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims.

Embodiments described herein may be discussed in the general context of computer-executable instructions residing on some form of computer-usable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “sending,” “processing,” “capturing,” “authenticating,” “uninstalling,” “uploading,” “encrypting” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

By way of example, and not limitation, computer-usable media may comprise non-transitory computer storage media and communication media. Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information.

Communication media can embody computer-readable instructions, data structures, program modules or other data and includes any information delivery media. By way of example, and not limitation, communication media includes wired media such as a wired network or direct-wired connection, and wireless media such as acoustic, radio frequency (RF), infrared and other wireless media. Combinations of any of the above should also be included within the scope of computer-readable media.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

In one embodiment, the present invention provides an electronic system with data protection functions. More specifically, if an unauthorized user attempts to use the electronic system, the electronic system can process the data and applications in the electronic system and prevent the unauthorized user from obtaining and/or accessing the data and applications.

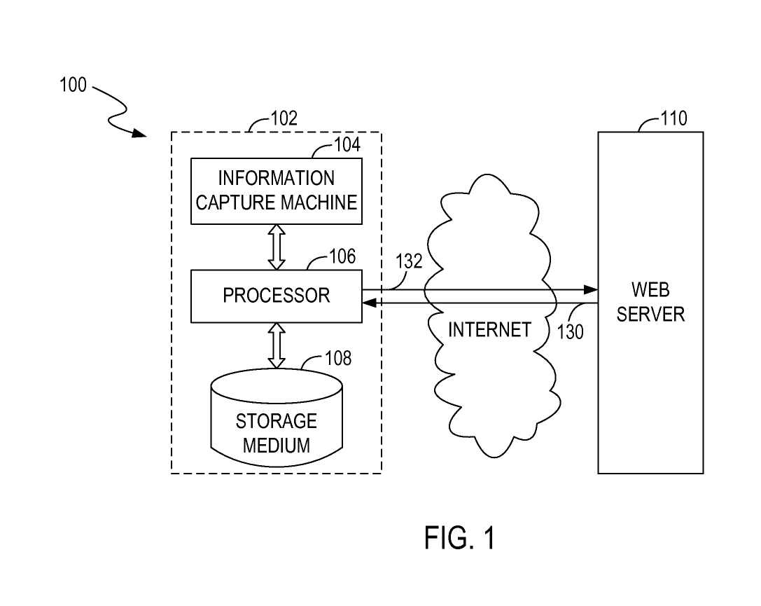

FIG. 1 illustrates a block diagram of an example of a network 100, e.g., a client-server (CS) network, in accordance with one embodiment of the present invention. The network 100 includes an electronic system, e.g., a client-end device 102, and a server system, e.g., a web server 110. The client-end device 102 can be any kind of device that is operable for storing data, processing data, executing applications, accessing the Internet, and authenticating information, e.g., image information or voice information. For example, the client-end device 102 can be, but is not limited to, a laptop computer, a palmtop computer, a smartphone, or the like.

More specifically, in one embodiment, the client-end device 102 includes an information capture machine 104, a processor 106 coupled to the information capture machine 104, and a non-transitory storage medium 108. The information capture machine 104, e.g., a camera or a recorder, can capture a facial image or record the voice of a user (e.g., for facial recognition or voice recognition purposes). The storage medium 108 stores content, e.g., data and applications, for the client-end device 102. The processor 106 can receive the information for the facial image (hereinafter, facial information) and/or the information for the recorded voice (hereinafter, voice information) from the information capture machine 104, and can authenticate the facial or voice information by searching an information database for the facial or voice information that is, e.g., stored in the storage medium 108. If the facial or voice information is found in the information database, the facial or voice information passes the authentication; otherwise, it fails to pass the authentication. The processor 106 processes the content, e.g., the data and applications, stored in the storage medium 108 according to the authentication result. In one embodiment, if the information from the information capture machine 104 fails to pass the authentication, the processor 106 performs a predefined action. The predefined action includes encrypting specified personal data stored in the storage medium 108 to a private drive, e.g., using the triple data encryption standard (3DES), the advanced encryption standard (AES), or the like. The predefined action may also include deleting specified personal data stored in the storage medium 108.

Additionally, if the information from the information capture machine 104 fails to pass the authentication, and the client-end device 102 is connected to the Internet, then the processor 106 can send a request 132 for an action list to the web server 110. In response to the request 132, the web server 110 can generate and send a reply 130 including the action list to the client-end device 102. The processor 106 also processes the content, e.g., the data and applications, stored in the storage medium 108 according to the reply 130. By way of example, the processor 106 generates a request 132 including an information list indicative of the data and applications in the storage medium 108, and sends the request 132 to the web server 110. The web server 110 receives the information list in the request 132 and generates an action list that includes one or more actions to be executed on the data and applications in the information list. The action list can include an action to uninstall/remove the applications in the client-end device 102, and/or an action to upload selected data, e.g., selected from the data and applications in the client-end device 102, to the web server 110. The action list may also include an action to remove specified personal data in the storage medium 108. The processor 106 can receive a reply 130 including the action list and can process the data and applications according to the action list.

In operation, in one embodiment, when the client-end device 102 is activated, e.g., when the client-end device 102 is powered on or when the client-end device 102 is activated from a stand-by mode or a sleep mode, the processor 106 generates an interrupt signal indicating, e.g., that the client-end device 102 is activated, to the information capture machine 104. In response to the interrupt signal, the information capture machine 104, e.g., an image capture machine, captures one or more images and sends information for the images to the processor 106. The processor 106 authenticates the information for the images. In other words, the client-end device 102 can perform an image authentication process automatically when the client-end device 102 is activated. For example, the client-end device 102 can compare the image information with corresponding information in the storage medium 108. In another embodiment, the client-end device 102 can perform a voice authentication process in a similar manner when the client-end device 102 is activated. The processor 106 processes the data and applications in the client-end device 102 according to a predefined action if the image information (or the voice information) fails to pass the authentication. In addition, if the image information (or the voice information) fails to pass the authentication and the client-end device 102 is connected to Internet, the processor 106 sends a request 132 to the web server 110. The processor 106 receives a reply 130 from the web server 110 and executes the one or more actions in the reply 130.

Advantageously, if the client-end device 102 is lost or stolen, execution of the predetermined action stored in the client-end device 102 and/or an action in the action list from the web server 110 can prevent an unauthorized user, e.g., a stranger or a thief, from accessing, obtaining, or processing the data and the applications in the client-end device 102. Thus, the data and applications in the client-end device 102 are protected.

Moreover, in one embodiment, if the information from the information capture machine 104 fails to pass the authentication, the processor 106 can send a data package to the web server 110. The data package can include the captured information and address information for the client-end device 102. The captured information can include the information for one or more images and/or the recorded voice of the unauthorized user who is using the client-end device 102. The address information can include a network address, e.g., an IP address or a Wi-Fi access point address. The address information can also include position information obtained via a 3G (third generation mobile telecommunication) network. By way of example, if the captured information fails to pass the authentication, the client-end device 102 can acquire its position information from a location provider via the 3G network. Advantageously, if the client-end device 102 is lost or stolen, the web server 110 can locate the client-end device 102 according to the address information. The web server 110 can also display a facial image of the unauthorized user on a screen, and/or play the voice of the unauthorized user over a speaker.

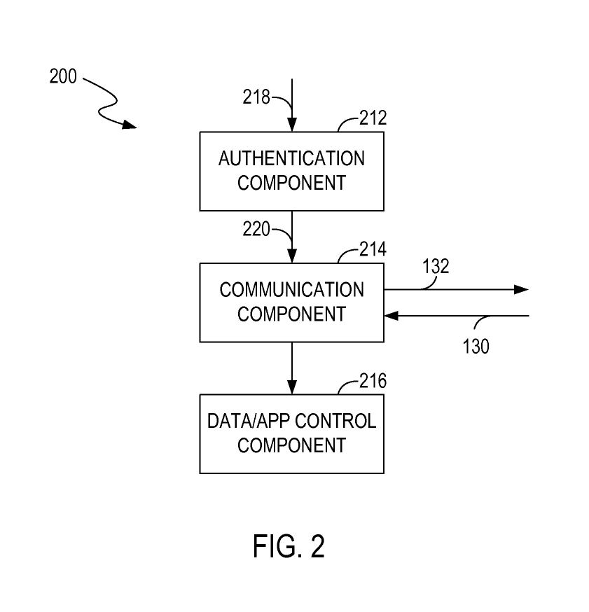

FIG. 2 illustrates an example of a software topology diagram 200 for the client-end device 102, in accordance with one embodiment of the present invention. FIG. 2 is described in combination with FIG. 1. In one embodiment, components 212, 214 and 216 are computer-executable components, e.g., computer-readable instructions, stored on a non-transitory computer-readable storage medium, e.g., a storage unit in the processor 106, an installation disk, or the like.

A storage unit (not shown in FIG. 1) in the processor 106 can store the authentication component 212, the communication component 214, and the data/application control component 216. The processor 106 can execute the authentication component 212 to authenticate information 218 captured by the information capture machine 104, and can generate an authentication result signal 220 that indicates whether or not the information 218 passed the authentication. The processor 106 can execute the communication component 214 to receive the authentication result signal 220. If the authentication result signal 220 indicates that the information 218 failed to pass the authentication, the processor 106 generates and sends a request 132 for an action list to the web server 110. The processor 106 further detects a reply 130 to the request 132 from the web server 110. The reply 130 includes the action list. When the client-end device 102 receives the reply 130, the processor 106 executes the control component 216 to process content, e.g., data and applications, in the client-end device 102 according to the actions included in the reply 130. Specifically, the client-end device 102 performs one or more of the actions in the action list. In addition, if the information 218 fails to pass the authentication, the processor 106 can also execute the control component 216 to process the content, e.g., the data and applications, in the client-end device 102 according to the aforementioned predefined action.

Moreover, in one embodiment, if the information 218 fails to pass the authentication, the processor 106 generates a data package that includes the information 218 and address information, e.g., a network address or physical position information, for the client-end device 102, and executes the communication component 214 to send the data package to the web server 110. Thus, the web server 110 can locate the client-end device 102 according to the address information. The web server 110 can also display the facial image of the person who is using the client-end device 102 on a screen, and/or play the voice of that person over a speaker.

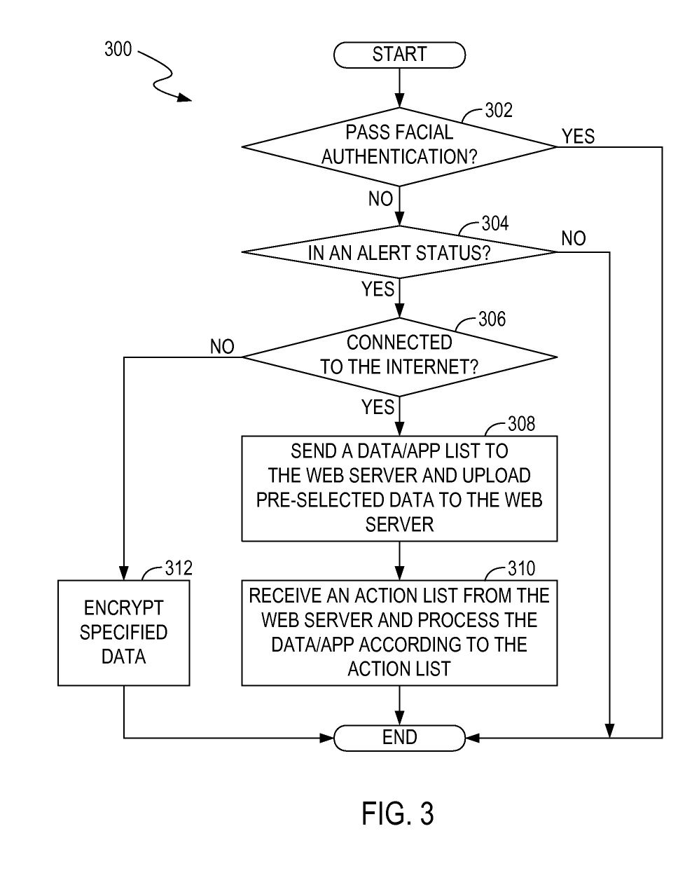

FIG. 3 illustrates a flowchart 300 of an example of a data protection/recovery process performed by the client-end device 102, in accordance with one embodiment of the present invention. Although specific steps are disclosed in FIG. 3, such steps are examples for illustrative purposes. That is, the present invention is well suited to performing various other steps or variations of the steps recited in FIG. 3. In one embodiment, the flowchart 300 is implemented as computer-executable instructions stored in a computer-readable medium. FIG. 3 is described in combination with FIG. 1 and FIG. 2.

In one embodiment, when the client-end device 102 is activated, e.g., when the client-end device 102 is powered on or when the client-end device 102 is activated from a stand-by mode or a sleep mode, the processor 106 instructs the information capture machine 104 (e.g., a camera) to capture facial information (e.g., one or more images) for a user. At step 302, the processor 106 executes the authentication component 212 to authenticate the facial information. If the captured facial information fails to pass the facial authentication, the flowchart 300 goes to step 304; otherwise, the flowchart 300 ends.

At step 304, the processor 106 checks whether the client-end device 102 is in an alert status. In one embodiment, a user manually places the client-end device 102 in an alert status. By way of example, the client-end device 102 may be in the alert status when the user is traveling with the client-end device 102 or when the user is using the client-end device 102 in a public place. The user can also place the client-end device 102 in a non-alert status. By way of example, the client-end device 102 can be in the non-alert status when the user is using the client-end device 102 in his/her office or at home. The user can place the client-end device 102 in an alert status or a non-alert status at any time. If the client-end device 102 is in an alert status, the flowchart 300 goes step 306; otherwise, the flowchart 300 ends.

At step 306, the processor 106 checks whether the client-end device 102 is connected to the Internet. If the client-end device 102 is connected to the Internet, the flowchart 300 goes to step 308; otherwise, the flowchart 300 goes to step 312.

At step 312, the processor 106 executes the control component 216 to perform a predefined action, e.g., encrypting specified data stored in the storage medium 108 to a private drive, e.g., using 3DES, AES, or the like. Although, in the example of FIG. 3, the processor 106 performs step 312 according to a status of connection to the Internet, the invention is not so limited. In another embodiment, if the captured facial information fails to pass the facial authentication, and the client-end device 102 is in an alert status, then the processor 106 performs step 312 whether the client-end device 102 is connected to the Internet or not.

At step 308, the processor 106 executes the communication component 214 to send a request 132, e.g., including a data/application list of the data and applications in the client-end device 102, to the web server 110. The processor 106 can also execute the communication component 214 to upload pre-selected data to the web server 110.

At step 310, the processor 106 receives a reply 130 including an action list from the web server 110. The processor 106 further processes the data and applications (data/app) in the client-end device 102 according to the action list. By way of example, according to the action list, the processor 106 can uninstall one or more applications in the client-end device 102, and/or upload selected data from the client-end device 102 to the web server 110, and/or remove specified data in the client-end device 102. Accordingly, the data and applications in the client-end device 102 can be protected.

In one embodiment, the client-end device 102 can also be placed in an alert status or a non-alert status at the web server 110. By way of example, if the client-end device 102 is lost or stolen, the user or an administrator of the web server 110 can place the client-end device 102 in the alert status at the web server 110. Thus, when the captured information fails to pass the authentication, the client-end device 102 performs steps 308 and 310 if the client-end device 102 is in the alert status, or ends the process if the client-end device 102 is in the non-alert status.

Furthermore, in one embodiment, if the user gets the client-end device 102 back, the alert-status for the client-end device 102 placed at the web server 110 can be dismissed. The client-end device 102 can also include a BIOS (basic input/output system) system configured to communicate with the web server 110 when the client-end device 102 is powered on. When the alert-status is dismissed, e.g., the client-end device 102 is in the non-alert status, the BIOS system can automatically download the data from the web server 110 that was previously uploaded to the web server 110. The BIOS system can further download applications from the web server 110 and install the applications in the client-end device 102. As a result, the data and applications can be recovered in the client-end device 102.

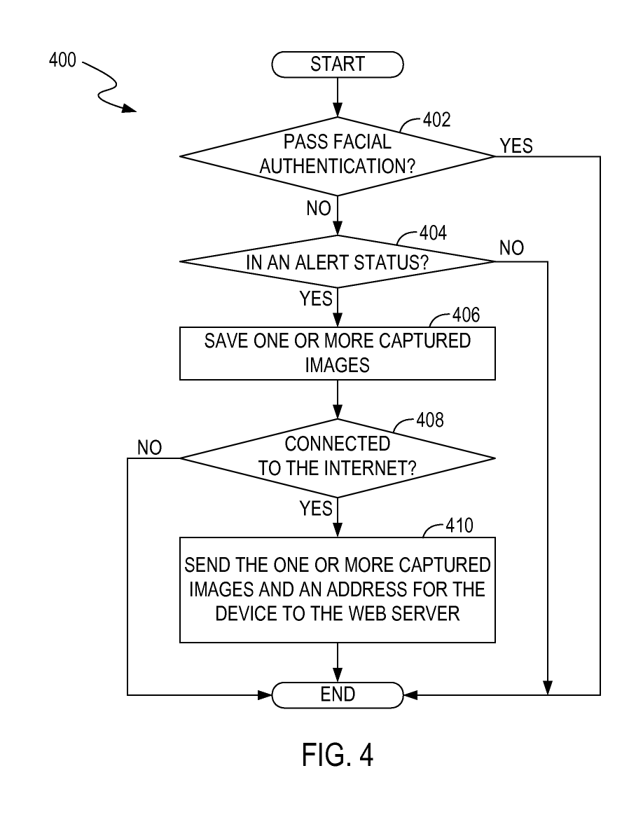

FIG. 4 illustrates a flowchart 400 of an example of a tracking process performed by the client-end device 102, in accordance with one embodiment of the present invention. Although specific steps are disclosed in FIG. 4, such steps are examples for illustrative purposes. That is, the present invention is well suited to performing various other steps or variations of the steps recited in FIG. 4. In one embodiment, the flowchart 400 is implemented as computer-executable instructions stored in a computer-readable medium. FIG. 4 is described in combination with FIG. 1, FIG. 2 and FIG. 3. The steps 402 and 404 in FIG. 4 are similar to steps 302 and 304 in FIG. 3.

At step 406, the processor 106 saves one or more of the captured images, e.g., by storing the images in the storage medium 108 or a storage unit of the processor 106. At step 408, the processor 106 checks whether the client-end device 102 is connected to the Internet. If the client-end device 102 is connected to the Internet, the flowchart 400 goes to step 410; otherwise, the flowchart 400 ends.

At step 410, the processor 106 sends one or more of the captured images to the web server 110. The processor 106 also sends address information, e.g., a network address or physical position information, for the client-end device 102 to the web server 110. Thus, the web server 110 can locate the client-end device 102. The web server 110 may also display facial images of the person who is using the client-end device 102.

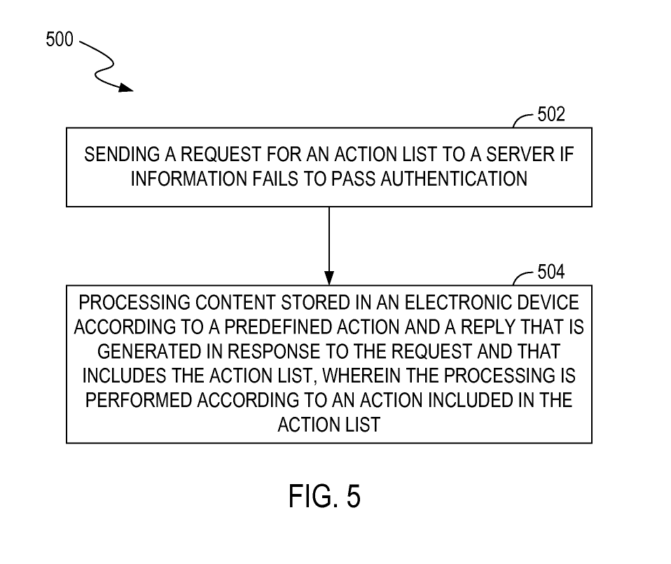

FIG. 5 illustrates a flowchart 500 of examples of operations performed by the client-end device 102, in accordance with one embodiment of the present invention. In one embodiment, the flowchart 500 is implemented as computer-executable instructions stored in a computer-readable medium. FIG. 5 is described in combination with FIG. 1, FIG. 2 and FIG. 3.

In one embodiment, the processor 106 executes the authentication component 212 to authenticate information captured by the information capture machine 104. In block 502, the processor 106 executes the communication component 214 to send a request 132 for an action list to the web server 110 if the information fails to pass the authentication.

In block 504, the processor 106 processes the content, e.g., the data and applications, stored in the client-end device 102 according to a predefined action and a reply 130 from the web server 110. The predefined action includes encrypting specified personal data stored in the storage medium 108 to a private drive and/or deleting specified personal data stored in the storage medium 108. If the information from the information capture machine 104 fails to pass the authentication, the processor 106 can perform the predefined action. In addition, the reply 130 is generated by the web server 110 in response to the request 132, and includes an action list. The processing of the content stored in the client-end device 102 can also be performed according to one or more actions included in the action list. According to the action list, the processor 106 can uninstall one or more applications in the client-end device 102, and/or upload selected data from the client-end device 102 to the web server 110, and/or remove specified data in the client-end device 102.

In summary, embodiments according to the present invention provide an electronic system with a data protection function. If an unauthorized user attempts to use the electronic system, the electronic system can perform a predefined action to protect the data and applications in the electronic system. The electronic system can also communicate with a server system to obtain an action list, and perform a protection/recovery process on the data and applications according to the action list. The electronic system can be used in many applications such as laptops, palmtop computers, and smartphones.

While the foregoing description and drawings represent embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. A non-transitory computer-readable storage medium having computer-executable components stored thereon, said computer-executable components comprising:
a communication component for sending a request for an action list to a server if information fails to pass authentication; and
a control component for processing content stored in an electronic device according to a reply generated in response to said request, said reply comprising said action list, wherein said processing is performed according to an action included in said action list.

2. The non-transitory computer-readable storage medium as claimed in claim 1, wherein said computer-executable components further comprise an authentication component for authenticating said information.

3. The non-transitory computer-readable storage medium as claimed in claim 1, wherein said information is captured in response to an interrupt signal that indicates said electronic device is activated.

4. The non-transitory computer-readable storage medium as claimed in claim 1, wherein said information comprises image information.

5. The non-transitory computer-readable storage medium as claimed in claim 1, wherein said request comprises an information list indicative of data and applications stored in said electronic device.

6. The non-transitory computer-readable storage medium as claimed in claim 5, wherein said action list comprises at least one action executable on said data and applications stored in said electronic device.

7. The non-transitory computer-readable storage medium as claimed in claim 5, wherein said action list comprises an action to uninstall an application of said data and applications.

8. The non-transitory computer-readable storage medium as claimed in claim 5, wherein said action list comprises an action to upload selected data of said data and applications to said server.

9. The non-transitory computer-readable storage medium as claimed in claim 1, wherein said control component executes a predefined action to encrypt said content if said information fails to pass said authentication.

10. A computer-implemented method comprising:
sending a request for an action list to a server if information fails to pass authentication; and
processing content stored in an electronic device according to a reply generated in response to said request, said reply comprising said action list, wherein said processing is performed according to an action included in said action list.

11. The computer-implemented method as claimed in claim 10, further comprising:
capturing said information in response to an interrupt signal that indicates said electronic device is activated; and
authenticating said information.

12. The computer-implemented method as claimed in claim 10, wherein said information comprises image information.

13. The computer-implemented method as claimed in claim 10, wherein said request comprises an information list indicative of data and applications stored in said electronic device.

14. The computer-implemented method as claimed in claim 13, wherein said processing said content comprises:
uninstalling an application of said data and applications according to an action of said action list.

15. The computer-implemented method as claimed in claim 13, wherein said processing said content comprises:
uploading selected data of said data and applications to said server according to an action of said action list.

16. The computer-implemented method as claimed in claim 10, wherein said processing said content comprises:
encrypting said content according to a predefined action if said information fails to pass said authentication.

17. An electronic system comprising:
a non-transitory storage medium operable for storing data and applications; and
a processor coupled to said non-transitory storage medium and operable for authenticating information, sending a request for an action list to a server system if said information fails to pass the authentication, and processing said data and applications according to a reply generated in response to said request, said reply comprising said action list, wherein said processing is performed according to an action included in said action list.

18. The electronic system as claimed in claim 17, further comprising an information capture machine coupled to said processor, and wherein said processor instructs said information capture machine to capture said information when said electronic system is activated.

19. The electronic system as claimed in claim 17, wherein said request comprises an information list indicative of said data and applications.

20. The electronic system as claimed in claim 17, wherein said action list comprises an action to uninstall an application of said data and applications.

21. The electronic system as claimed in claim 17, wherein said action list comprises an action to upload selected data of said data and applications to said server system.

22. The electronic system as claimed in claim 17, wherein said processor executes a predefined action to encrypt data of said data and applications if said information fails to pass the authentication.
